(19) United States
(12) Patent Application Publication
(10) Pub. No.: US 2016/0265633 A1
(43) Pub. Date: Sep. 15, 2016

(54) Chain Guiding Device for Bicycles

(71) Applicant: TH Industries Co., Ltd., Taichung (TW)

(72) Inventor: Jason Miles, Seattle, WA (US)

(21) Appl. No.: 14/720,994

(22) Filed: May 26, 2015

(30) Foreign Application Priority Data
Mar. 13, 2015 (TW) 104203810

(51) Int. Cl. F16H 7/18; F16H 7/20

(52) U.S. Cl. CPC F16H 7/18; F16H 7/20

(57) ABSTRACT

A chain guiding device for bicycles comprises a main body, a chain guiding unit, a fixing unit and a control unit. The main body is installed onto a bicycle frame. The bicycle frame is installed with a crankset. The main body has two base units, respectively arranged at an upper portion and a lower portion of the main body and having two fixing holes. The two chain guiding units are respectively pivotally connected to the upper portion and the lower portion, can rotate toward or away from the crankset, and are each formed with a through hole for alignment with the respective fixing holes. The fixing units fix the chain guiding units to the main body. The two control units are respectively connected to the fixing units for driving the fixing units to pass through or separate from the fixing holes.

### FIELD OF THE INVENTION

The present invention relates to a chain guiding device, and more particularly to a chain guiding device for bicycles.

### BACKGROUND OF THE INVENTION

With rising importance of leisure time and sports in human lives, bicycles are no longer merely modes of transportation, but also a type of leisure or sport equipment. Therefore, safety of bicycles is particularly emphasized. The most common problems of bicycles relate to the tires and chains. Structural improvements to tires have reached considerable standards, and many dangers are therefore prevented. However, significant room for improvement exists regarding safety of the chains.

Regarding a typical bicycle using a chain, given that the length of the chain differs after usage, the fluidity of transition of the chain on chain rings is affected. Deformity of the chain due to long period of use, or swinging of the chain by riding in rugged terrain, can cause the chain to detach from the chain rings. In order to prevent the detachment of the chain from the chain rings, a common practice in the industry applies a chain guiding device to restrict and guide the motion of the chain.

Traditional chain guiding devices can solve the problem of chain detachment. However, during assembly, a main body of the chain guiding device is installed on the frame of bicycle by using special tools, the chain rings are installed and then a chain guiding unit is screwed onto the main body, and a chain is finally mounted to complete an installation of a traditional chain guiding device. The assembly process is complicated and requires special tools. The complicated assembly process likely results in abrasion or loosening of the guiding chain device during the assembly process, thereby affecting the safety and the lifespan of the chain guiding device. Additionally, when a user intends to change to a chain ring of greater dimension, the larger chain rings cannot be quickly assembled within traditional chain guiding devices and the complicated assembly process needs to be repeated, bringing about inconvenience for the user.

### SUMMARY OF THE INVENTION

The present disclosure provides a chain guiding device for bicycles, to solve problems caused by conventional techniques.

The present invention discloses a chain guiding device for a bicycle and installed on a bicycle frame. The chain guiding device includes a main body, a chain guiding unit, and a fixing unit. The main body has at least one base unit formed with a fixing hole. The chain guiding unit is pivotally connected to the main body for moving toward and away from a crankset arranged on a bicycle frame. The fixing unit is movably disposed at the chain guiding unit and joinable to the fixing hole for selectively fixing the chain guiding unit appropriately close to the crankset.

In one embodiment, the chain guiding unit has a through hole arranged correspondingly to the fixing hole, and the fixing unit movably passes through the through hole and the fixing hole.

In one embodiment, the chain guiding device further includes a control unit disposed at the fixing unit for driving the fixing unit to insert into or separate from the through hole and the fixing hole.

In one embodiment, the chain guiding device further includes a pivotal connection unit passing through the chain guiding unit at the base unit and consequently the chain guiding unit is pivotally connected to the main body.

In one embodiment, the main body has an upper portion, a lower portion, and at least a sliding space formed at the upper portion or the lower portion for providing the base unit to move along the sliding space at the main body.

In one embodiment, the chain guiding device further includes a pivotal connection unit passing through the chain guiding unit and the base unit at the corresponding sliding space, pivotally connecting the chain guiding unit to the main body.

In one embodiment, the pivotal connection unit and the base unit are formed with screw threads for screwing the pivotal connection unit to the base unit.

In one embodiment, the chain guiding unit includes a groove arranged at an outer surface thereof for disposing the control unit.

In one embodiment, the control unit includes a connecting element and a gripping portion. The connecting element is arranged at the fixing unit. The gripping portion is disposed in the groove when the fixing unit fixes the chain guiding unit.

In one embodiment, the chain guiding unit includes at least one guiding cog disposed inside the chain guiding unit.

Regarding the chain guiding device of the present embodiment, the control unit can drive the fixing unit to insert into or separate from the fixing hole and the through hole, allowing a user to easily handle the control unit without using additional tools and quickly rotate the chain guiding unit away from a side wall of the main body so the crankset of the bicycle can be assembled onto or disassembled from the main body of the chain guiding device, achieving the effect of quick assembly or disassembly. In the assembly process, only the fixing unit is assembled to the fixing hole and the through hole. Therefore, abrasion between and loosening of components during assembly and disassembly of the chain guiding device is avoided.

### BRIEF DESCRIPTION OF THE DRAWINGS

The present invention will become more readily apparent to those ordinarily skilled in the art after reviewing the following detailed description and accompanying drawings, in which:

FIG. 1 shows a perspective view of a chain guiding device applied to a bicycle according to a first embodiment of the present disclosure;

FIG. 2 shows an exploded view of the chain guiding device of FIG. 1 and a crankset;

FIG. 3 shows a perspective view of a chain guiding device applied to a bicycle according to a second embodiment of the present disclosure;

FIG. 4 shows an exploded view of the chain guiding device of FIG. 3 and a crankset; and

FIG. 5 to FIG. 7 shows steps of disengagement between a chain guiding device and a crankset.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

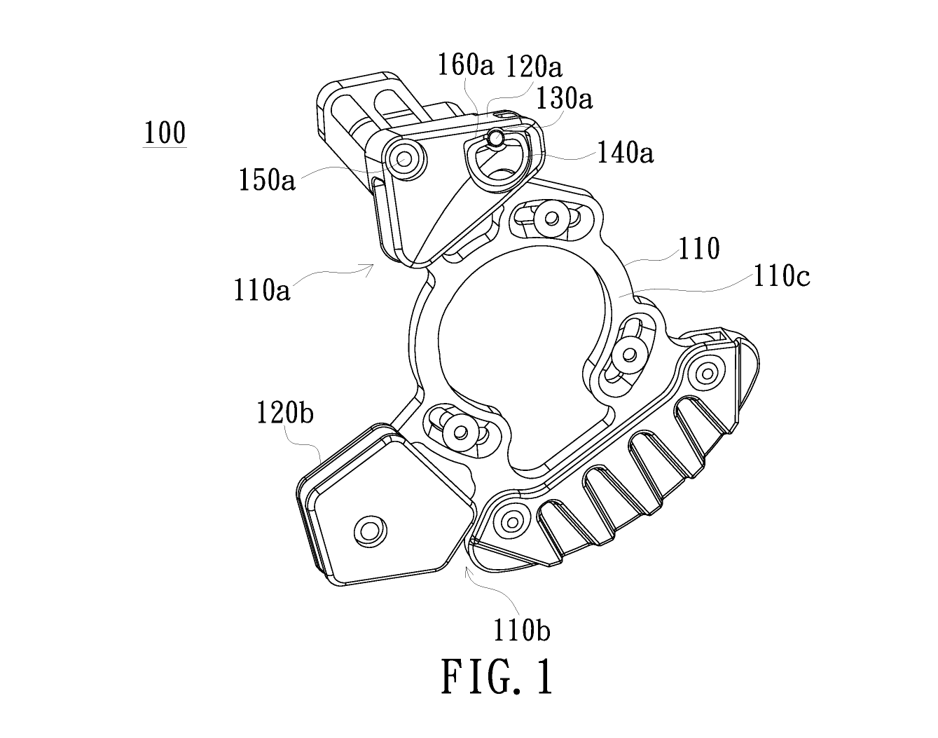

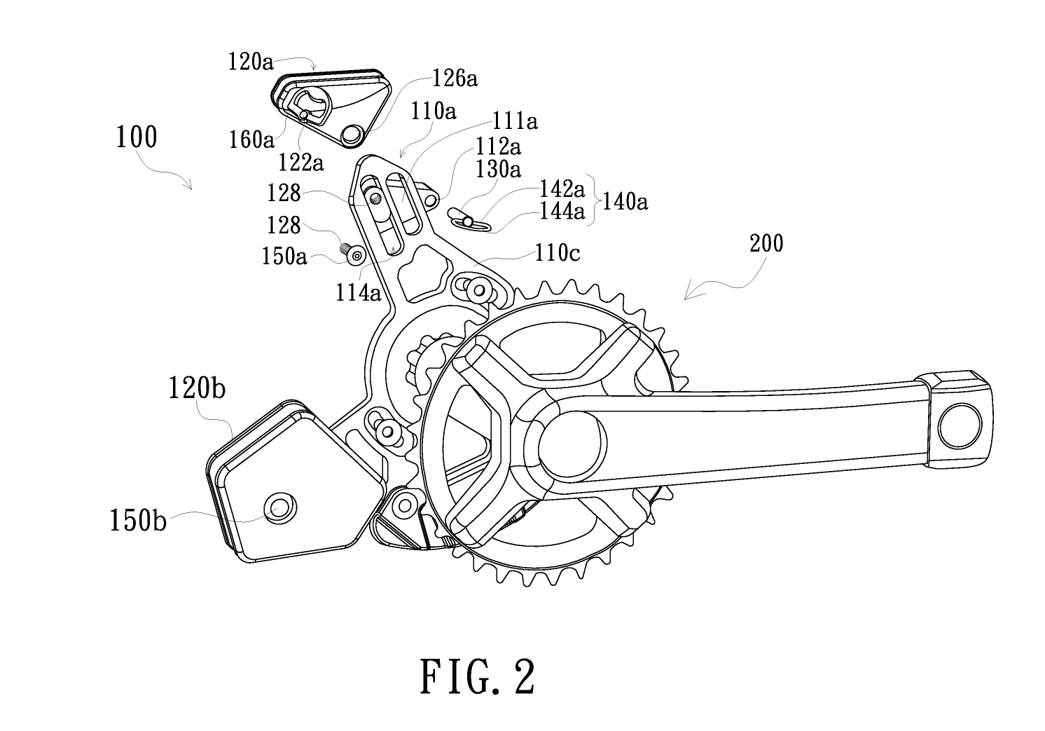

FIG. 1 shows a perspective view of a chain guiding device applied to a bicycle according to a first embodiment of the present disclosure. FIG. 2 shows an exploded view of the chain guiding device of FIG. 1 and a crankset. As shown in FIG. 1 and FIG. 2, a chain guiding device 100 of the first embodiment is installed on a bicycle frame (not shown in the figures) and includes a main body 110, chain guiding units 120a/120b, a fixing unit 130a, and a control unit 140a. The main body 110 has a base unit 111a arranged at an upper portion 110a of the main body 110. The base unit 111a is formed with a fixing hole 112a. In the present embodiment, the main body 110 can be connected to the bicycle frame. The crankset 200 is arranged to pass through the bicycle frame and is proximal to a side wall 110c of the main body 110.

The chain guiding unit 120a is pivotally connected to the main body 110 and selectively pivoted toward or away from the crankset 200 arranged on the bicycle frame. The fixing unit 130a is movably arranged at the chain guiding unit 120a and joinable to the fixing hole 112a, for selectively fixing the chain guiding unit 120a at a position appropriately close to the crankset 200.

Specifically, the chain guiding unit 120a is formed with a through hole 122a. The through hole 122a is configured to align to the fixing hole 112a of the base unit 111a when the chain guiding unit 120a is rotated to a specific position. The fixing unit 130a can movably pass through the through hole 122a and the fixing hole 112a. Thus, when the fixing unit 130a passes through the through hole 122a and the fixing hole 112a, the fixing unit 130a fixes the chain guiding unit 120a at the base unit 111a proximal to the side wall 110c of the main body 110.

In the first embodiment, the main body 110 may have a pivotal connection unit 150a and a sliding space 114a, positioned at the upper portion 110a of the main body 110 but not limited thereto. The sliding space 114a allows the chain guiding unit 120a to be adjustably pivoted on the base unit 111a through the pivotal connection unit 150a. The pivotal connection unit 150a and the base unit 111a are each formed with a screw thread 128, such that the pivotal connection unit 150a can be fixed to the base unit 111a through the screw threads 128. Namely, the chain guiding unit 120a is removably fixed to the base unit 111a by the pivotal connection unit 150a through a pivot hole 126a. When the fixing unit 130a does not pass through the chain guiding unit 120a and the fixing hole 112a through the through hole 122a, the chain guiding unit 120a can pivot about the pivotal connection unit 150a. When the pivotal connection unit 150a is not fixed to the base unit 111a, the pivotal connection unit 150a and the base unit 111a can shift along the sliding space 114a and drive the chain guiding unit 120a to shift along the sliding space 114a.

In the first embodiment, the chain guiding unit 120a includes a groove 160a arranged at an outer surface thereof. When the corresponding fixing unit 130a fixes the chain guiding unit 120a to the main body 110 through the through hole 122a, the groove 160a can dispose the control unit 140a.

Additionally, the control unit 140a is connected to the fixing unit 130a for driving the fixing unit 130a to insert into or separate from the through hole 122a and the fixing hole 112a. Specifically, the control unit 140a of the present embodiment may include a connecting element, for example, a beam 142a and a gripping portion 144a connected to each other. The beam 142a rotatably passes through the corresponding fixing unit 130a, such that the gripping portion 144a may be disposed onto or out of the groove 160a. For example, a user can hold the gripping portion 144a and pull the control unit 140a to drive the fixing unit 130a to separate from the through hole 122a and the fixing hole 112a, such that the chain guiding unit 120a can rotate with respect to the main body 110 by pivoting about the pivotal connection unit 150a/150b. Alternately, the user can hold the gripping portion 144a and push the control unit 140a to drive the fixing unit 130a to pass through the through hole 122a and the fixing hole 112a, such that the chain guiding unit 120a is fixed at the main body 110 and cannot be rotated. In such configuration, the crankset 200 can be quickly assembled or disassembled.

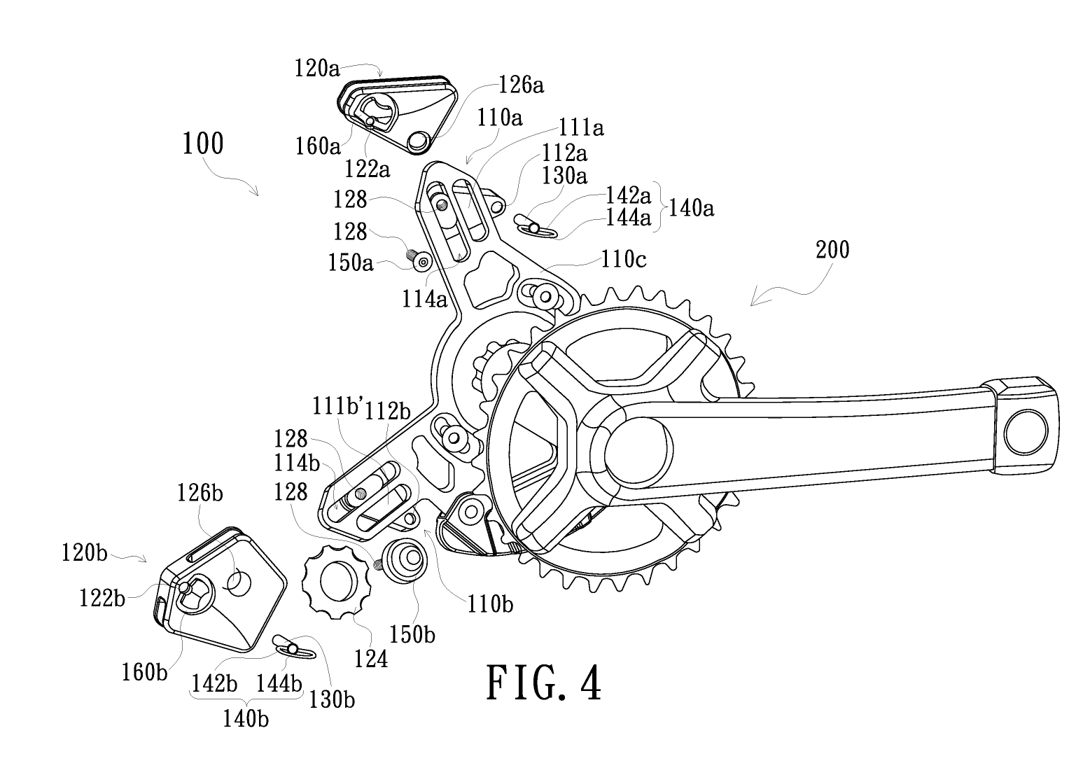

In the first embodiment, a chain (not shown in the figures) arranged on the crankset 200 can pass through the chain guiding units 120a/120b and be restricted thereby from detaching from the crankset 200. Additionally, the chain guiding units 120a/120b can guide the direction of motion of the chain. In the first embodiment, the chain guiding unit 120b includes a guiding cog 124 (shown in FIG. 4) disposed therein and passed through by the pivotal connection unit 150b. The guiding cog 124 can engage the chain for guiding the direction of motion of the chain, but is not limited thereto.

Additionally, in the first embodiment, the chain guiding unit 120b can be disposed at the lower portion 110b of the main body 110, but is not limited thereto. In other embodiments, the chain guiding unit 120b can be formed with a groove at an outer surface thereof and a control unit can be disposed on the fixing unit, but are not limited thereto.

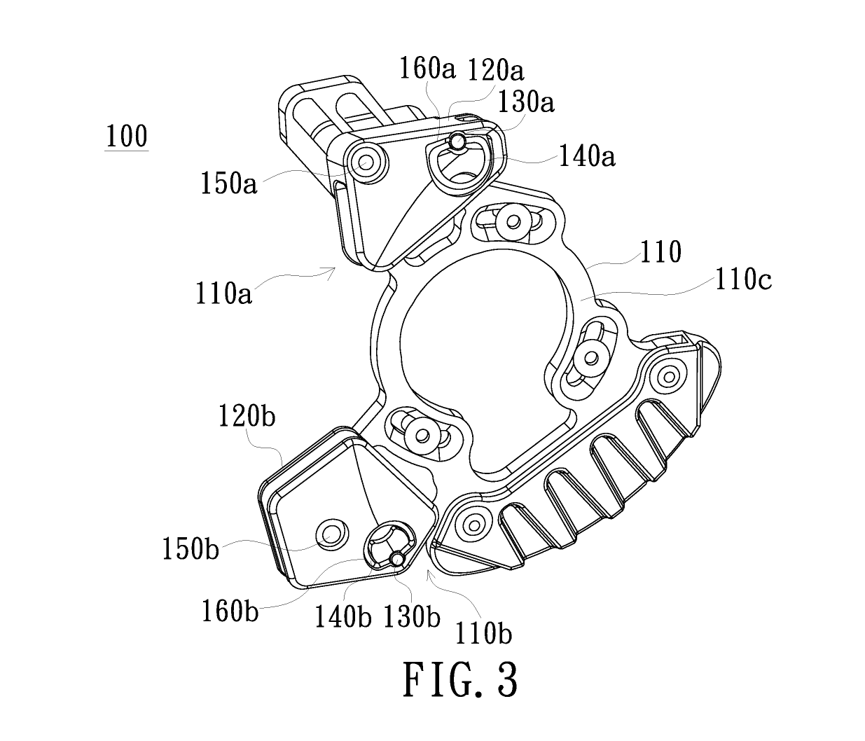

FIG. 3 shows a perspective view of a chain guiding device applied to a bicycle according to a second embodiment of the present disclosure. FIG. 4 shows an exploded view of the chain guiding device of FIG. 3 and a crankset. As shown in FIG. 3 and FIG. 4, a chain guiding device 100 of the second embodiment is disposed on a bicycle frame (not shown in the figures) and includes a main body 110, chain guiding units 120a/120b, fixing units 130a/130b, and control units 140a/140b. The main body 110 has base units 111a/b′ respectively arranged at an upper portion 110a and a lower portion 110b of the main body 110. The base units 111a/111b′ are formed respectively with fixing holes 112a/112b. Namely, the upper portion 110a of the main body 110 has the base unit 111a formed with the fixing hole 112a, and the lower portion 110b of the main body 110 has the base unit 111b′ formed with the fixing hole 112b, but are not limited thereto. The chain guiding units 120a/120b are pivotally connected to the main body 110, for moving toward and away from the crankset 200 passing through the bicycle frame. The fixing units 130a/130b are movably arranged at the chain guiding units 120a/120b and joinable to the fixing holes 112a/112b respectively, for selectively fixing the chain guiding units 120a/120b at positions appropriately close to the crankset 200.

Specifically, the chain guiding units 120a/120b are formed with through holes 122a/122b. The through holes 122a/122b are configured to align to the fixing holes 112a/112b of the base units 111a/111b′ when the chain guiding units 120a/120b are rotated to specific positions. The fixing units 130a/130b removably pass through the through holes 122a/122b and the fixing holes 112a/112b. Namely, the chain guiding units 120a/120b are formed with the through holes 122a/122b arranged correspondingly to the fixing holes 112a/112b, and the fixing units 130a/130b may movably pass through the through holes 122a/122b and the fixing holes 112a/112b. When the fixing units 130a/130b pass through the through holes 122a/122b and the fixing holes 112a/112b, the fixing units 130a/130b fix the chain guiding units 120a/120b at the base units 111a/111b′ proximal to the side wall 110c of the main body 110.

The chain guiding units 120a/120b are pivotally connected to the main body 110, for moving toward and away from the crankset 200 arranged on the bicycle frame. The fixing units 130a/130b are movably arranged at the chain guiding units 120a/120b and joinable to the fixing holes 112a/112b, for selectively fixing the chain guiding units 120a/120b at positions appropriately close to the crankset 200.

Namely, the two chain guiding units 120a/120b are respectively pivotally connected to the upper portion 110a and the lower portion 110b of the main body 110. The chain guiding units 120a/120b can rotate to move toward or away from the side wall 110c of the main body 110. Specifically, the chain guiding device 100 of the present embodiment includes two pivotal connection units 150a/150b. The pivotal connection units 150a/150b pass through respective pivot holes 126a/126b of the base units 111a/111b′. The pivotal connection units 150a/150b and the base units 111a/111b′ are each formed with a screw thread 128. The chain guiding units 120a/120b are fixed to the base units 111a/111b′ through the screw threads 128 and pivotally connected to the main body 110, such that the chain guiding units 120a/120b can be rotated toward or away from the main body 110.

In the second embodiment, the main body 110 has two sliding spaces 114a/114b, respectively positioned at the upper portion 110a and the lower portion 110b of the main body 110 but not limited thereto. The sliding spaces 114a/114b allow the chain guiding units 120a/120b to be adjustably pivoted on the base units 111a/111b′, respectively. Namely, the chain guiding units 120a/120b are removably fixed to the base units 111a/111b′ at specific positions on the sliding spaces 114a/114b, by the pivotal connection units 150a/150b through the screw threads 128. The chain guiding units 120a/120b can rotate at said specific positions. After the pivotal connection units 150a/150b disengage the base units 111a/111b′ from the sliding spaces 114a/114b, the base units 111a/111b′ can shift along the sliding spaces 114a/114b and drive the chain guiding units 120a/120b to shift along the sliding spaces 114a/114b.

The chain guiding units 120a/120b are each formed with a through hole 122a/122b. The through holes 122a/122b are configured to align to the fixing holes 112a/112b of the base units 111a/111b′ when the chain guiding units 120a/120b are rotated to specific positions. The two fixing units 130a/130b can respectively movably pass through the through holes 122a/122b and the fixing holes 112a/112b. Therefore, when the fixing units 130a/130b respectively pass through the through holes 122a/122b and the fixing holes 112a/112b, the fixing units 130a/130b fix the chain guiding units 120a/120b at the base units 111a/111b′ proximal to the side wall 110c of the main body 110. In such configuration, a chain (not shown in the figures) arranged on the crankset 200 can pass through the chain guiding units 120a/120b and be restricted thereby from detaching from the crankset 200. Additionally, the chain guiding units 120a/120b can guide the direction of motion of the chain. In the present embodiment, the chain guiding unit 120b includes a guiding cog 124 disposed therein and passed through by the pivotal connection unit 150b. The guiding cog 124 can engage the chain (not shown in the figures) for guiding the direction of motion of the chain, but is not limited thereto. In other embodiments, the guiding cog 124 can be disposed in the chain guiding unit 120a, or guiding cogs can be disposed respectively in the chain guiding units 120a/120b, but are not limited thereto.

In the second embodiment, the chain guiding units 120a/120b each include a groove 160a/160b arranged at outer surfaces thereof. When the corresponding fixing units 130a/130b fix the chain guiding units 120a/120b to the main body 110, the grooves 160a/160b can accommodate the respective control units 140a/140b.

Additionally, the control units 140a/140b are respectively connected to the fixing units 130a/130b for driving the fixing units 130a/130b to insert into or separate from the through holes 122a/122b and the fixing holes 112a/112b. Specifically, the control units 140a/140b of the present embodiment can each include a connecting element, for example, a beam 142a/142b and a gripping portion 144a/144b connected to each other. The beams 142a/142b rotatably passes through the corresponding fixing units 130a/130b, such that the gripping portions 144a/144b may dispose onto or out of the grooves 160a/160b. For example, the user can hold the gripping portions 144a/144b and pull the control units 140a/140b to drive the fixing units 130a/130b to disengage from the through holes 122a/122b and the fixing holes 112a/112b, such that the chain guiding units 120a/120b can rotate with respect to the main body 110 by pivoting about the pivotal connection units 150a/150b. Alternately, the user can hold the gripping portions 144a/144b and push the control units 140a/140b to drive the fixing units 130a/130b to pass through the through holes 122a/122b and the fixing holes 112a/112b, such that the chain guiding units 120a/120b are fixed at the main body 110 and cannot be rotated. In the present embodiment, the control units 140a/140b are both ring-shaped, but are not limited thereto.

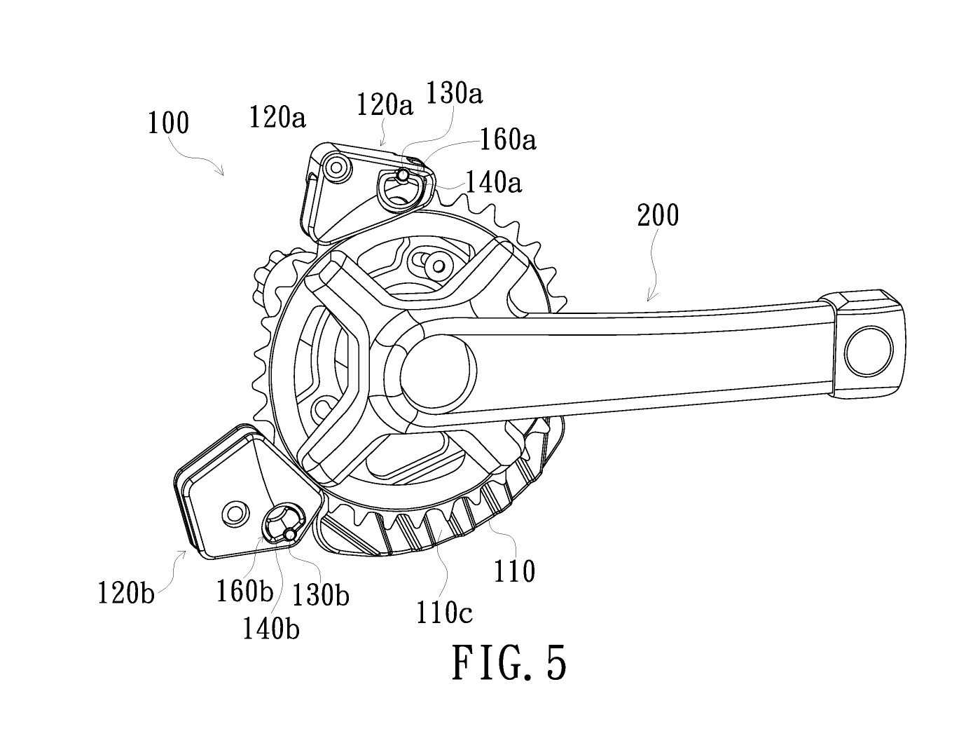

Assembly and disassembly of the chain guiding devices and the cranksets of the first and second embodiments are similar. Namely, the two embodiments apply similar methods to achieve an effect of quick disassembly. FIG. 5 to FIG. 7 shows the steps of disengagement of the crankset from the chain guiding device.

As shown in FIG. 5, when the chain guiding device 100 and the crankset 200 of the second embodiment are assembled, the fixing units 130a/130b insert into the fixing holes 112a/112b (the fixing holes 112a/112b are shown in FIG. 4) of the base units 111a/111b′, and fix the chain guiding units 120a/120b onto the main body 110. Additionally, the control units 140a/140b are disposed in the grooves 160a/160b. In other embodiments 140a/140b can be removably engaged in the grooves 160a/160b, but are not limited thereto.

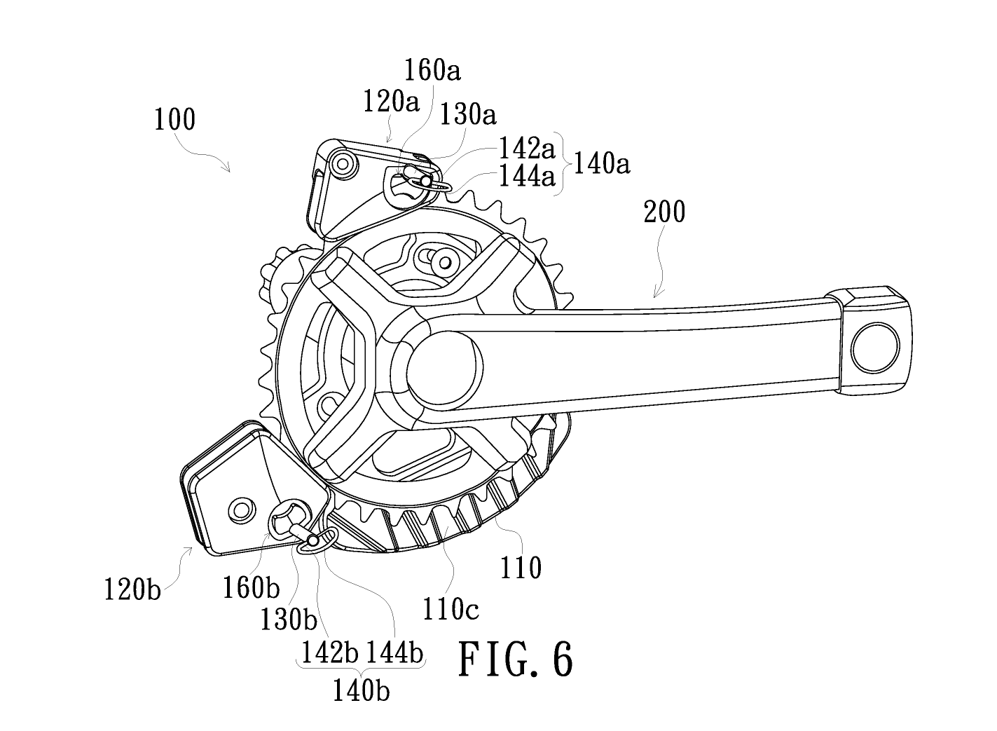

Next, as shown in FIG. 6, the gripping portions 144a/144b of the control units 140a/140b are flipped outward with respect to the respective grooves 160a/160b, such that the user can hold the gripping portions 144a/144b and pull the control units 140a/140b to drive the fixing units 130a/130b to separate from the through holes 122a/122b and the fixing holes 112a/112b (the fixing holes 112a/112b are shown in FIG. 4).

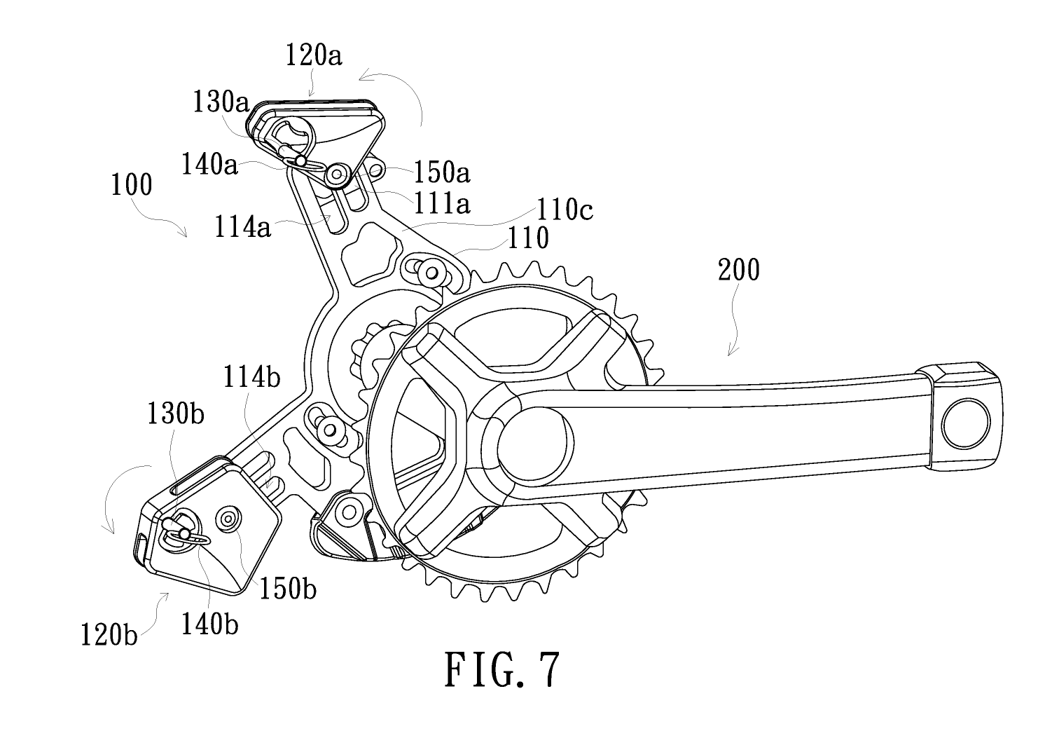

Furthermore, as shown in FIG. 7, the fixing units 130a/130b are separated from the through holes 122a/122b (the through holes 122a/122b are shown in FIG. 4) and the fixing holes 112a/112b (the fixing holes 112a/112b are shown in FIG. 4), therefore the chain guiding units 120a/120b may rotate with respect to the main body 110 by pivoting about the pivotal connection units 150a/150b and move away from the side wall 110c of the main body 110, such that the crankset 200 can be disassembled from the main body 110. It should be noted that the direction of rotation of the chain guiding units 120a/120b with respect to the main body 110 can be clock-wise or counter-clock-wise. Additionally, the angles of rotations of the chain guiding units 120a/120b with respect to the main body 110 may be 360 degrees, but are not limited thereto. After the pivotal connection units 150a/150b and the base unit 111a disengage from the sliding spaces 114a/114b, the base unit 111a may move upward along the sliding spaces 114a/114b and drive the chain guiding units 120a/120b to shift along the sliding spaces 114a/114b, so as to move the chain guiding units 120a/120b away from the ax is of the main body 110, thereby increasing an accommodating space on the side wall 110c of the main body 110 and allowing a crankset of greater dimension to be disassembled from the main body 110.

It should be noted that while FIG. 5 through FIG. 7 show a disassembly process of the chain guiding device 100 and the crankset 200 of FIG. 3, an assembly process of the chain guiding device 100 and the crankset 200 can be understood by reading FIG. 7 through FIG. 5.

The present disclosure has the following advantages. The control unit of the chain guiding device according to the present disclosure can drive the fixing unit to pass through or separate from the fixing hole and the through hole. Users may easily operate the control unit without using additional tools to quickly rotate the chain guiding unit away from the main body for the crankset of the bicycle to be assembled onto or disassembled from the main body of the chain guiding device. Quick assembly and disassembly are thereby achieved. The assembly process only assembles the fixing unit to the fixing hole and the through hole, therefore abrasion between and loosening of components during assembly and disassembly of the chain guiding device is avoided. Furthermore, the control unit can be accommodated in the corresponding groove, preventing the control unit from displacement due to vibration during operation of the chain guiding device in a ride leading to detachment of the fixing unit. Additionally, when the pivotal connection unit is disengaged from the base unit, the chain guiding unit can shift along the sliding space, such that the main body gains a greater room for accommodating the crankset.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A chain guiding device for a bicycle and installed on a bicycle frame, comprising:
a main body having at least one base unit, wherein the base unit is formed with a fixing hole and disposed at the main body;
a chain guiding unit pivotally connected to the main body for moving toward and away from a crankset mounted to the bicycle frame; and
a fixing unit movably disposed at the chain guiding unit and joinable to the fixing hole, for fixing the chain guiding unit to the main body.

2. The chain guiding device according to claim 1, wherein the chain guiding unit has a through hole arranged correspondingly to the fixing hole, and the fixing unit movably passes through the through hole and the fixing hole.

3. The chain guiding device according to claim 1, further comprising a control unit arranged at the fixing unit for driving the fixing unit to pass through or separate from the fixing hole.

4. The chain guiding device according to claim 1, further comprising a pivotal connection unit passing through the chain guiding unit at the base unit and consequently the chain guiding unit is pivotally connected to the main body.

5. The chain guiding device according to claim 1, wherein the main body has an upper portion, a lower portion and at least a sliding space arranged at the upper portion or the lower portion, for providing the base unit to move along the sliding space at the main body.

6. The chain guiding device according to claim 5, further comprising a pivotal connection unit passing through the chain guiding unit and the base unit and disposed in the sliding space, and the chain guiding unit is pivotally connected to the main body through the pivotal connection unit.

7. The chain guiding device according to claim 4, wherein the pivotal connection unit and the base unit are each formed with a screw thread, for screwing the pivotal connection unit to the base unit.

8. The chain guiding device according to claim 3, wherein the chain guiding unit comprises a groove arranged at an outer surface of the chain guiding unit for disposing the control unit.

9. The chain guiding device according to claim 8, wherein the control unit comprises a connecting element and a gripping portion, the connecting element is arranged at the fixing unit, and the gripping portion is disposed in the groove when the fixing unit fixes the chain guiding unit.

10. The chain guiding device according to claim 1, wherein the chain guiding unit comprises at least one guiding cog disposed inside the chain guiding unit.
